(19) United States
(12) Patent Application Publication
(10) Pub. No.: US 2008/0150662 A1
(43) Pub. Date: Jun. 26, 2008

(54) MAGNETIC RESTRAINING SYSTEM

(76) Inventor: Clifton Broumand, Hyattsville, MD (US)

Correspondence Address: CLIFTON BROUMAND, 3706 WEST STREET, LANDOVER, MD, 20785, US

(21) Appl. No.: 11/615,478

(22) Filed: Dec. 22, 2006

(51) Int. Cl. H01F 7/02

(52) U.S. Cl. 335/285

(57) ABSTRACT

This invention is about a magnetic restraining system. Keeping non electronics or electronics devices such as keyboards and mice stabilized on moving or non moving carts can be very difficult. This invention solves this problem by using a magnet that can be embedded inside the device or glued at the bottom of the device to prevent the device from sliding or falling from any metallic surface that can be attracted by a magnet. The metallic surface can be with or with out coating or covering.

### FIELD OF THE INVENTION

The present invention relates to restraining system and, more particularly, to a magnetic restraining system.

### BACKGROUND OF THE INVENTION

This invention relates to a restraining system, specifically to a magnetic restraining system that uses a magnet to hold down devices on a metallic surface that can be attracted by a magnet. Keeping devices such as keyboards, mice and speakers stabilized on moving or non moving tables, desks or carts can be very difficult. However, if they are not properly stabilized or attached to the surface they can slide or fall of the table.

My invention solves this problem by using a magnet inside a sealed enclosure to hold a device in place. A magnet can also be used to replace the feet of a device such as mice and keyboards. The magnet should be strong enough to hold down the device on a metallic surface with or without a coating or covering. The strength and size of the magnet depends on the weight of the device. A sealed enclosure for the magnet can be used not only to hold the magnet in one place but also to protect the magnet from corrosion.

It is therefore an object of the invention to put a magnet inside or outside any device so that it can be used as a restraining system on a metallic surface.

### SUMMARY OF THE INVENTION

To create a magnetic restraining system a magnet can be embedded inside or glued at the bottom of a device. The strength, the number and the size of the magnets depend on the weight of the device and the inclination of the surface. The magnet should be securely embedded in the device to prevent any movement with in the device. It should also be able to be detected at the bottom of the device.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a bottom section view of embedded magnets inside a device constructed in accordance with the invention.

FIG. 2 is a bottom view of four magnets used as a mouse feet constructed in accordance with the invention.

For purposes of clarity and brevity, like elements and components will bear the same designations and numbering throughout the Figures.

### DESCRIPTION OF THE PREFERRED EMBODIMENT

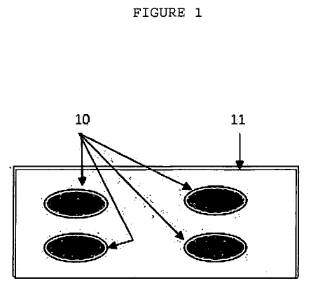

FIG. 1 is a bottom section view of embedded magnets inside device 11. One or more magnets can be embedded anywhere in the device as long as it does not interfere with the functionality of device 11 and the magnetic field has enough strength to be detected at the bottom. Magnet 10 can be placed in the bottom or side cover of device 11 for better results. The device can be electronics or non electronic. Magnet 10 has to be securely placed in side the device to prevent it from moving, wearing out or breaking. A metallic surface that can be attracted by the embedded magnet 10 has to be used to secure the device on the surface.

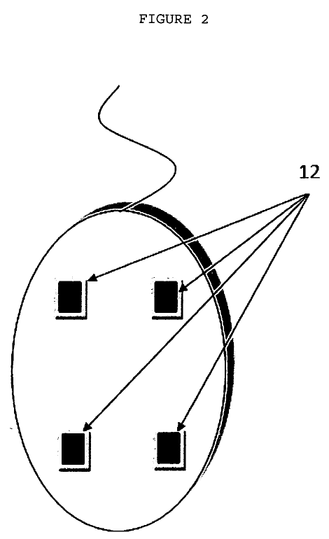

FIG. 2 is a bottom view of a mouse with four magnets. In this case the magnets are used as mice feet. For example, the magnets can be glued down to the bottom of the mouse. The invention applies to any electronic or non electronic device.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A magnetic restraining system for electronic and non electronic devices that can be used on a metallic surface, comprising: an embedded magnet within hermetically sealed devices, to provide a force to hold down a device on a metallic surface with or without coating and covering.

2. A magnetic restraining system for electronics and non electronics devices that can be used on a metallic surface, comprising: a magnet as device feet, to hold down the device on a metallic surface with or without coating or covering.

3. A magnetic restraining system for keyboards, comprising: an embedded magnet to hold down the keyboard on a metallic surface with or without coating or covering.

4. A magnetic restraining system for mice, comprising: an embedded magnet to hold down the mouse on a metallic surface with or without coating or covering.

5. A magnetic restraining system for keyboards, comprising: non-corrosive magnet feet for the keyboard to secure the keyboard on a metallic surface with or without coating or covering.

6. A magnetic restraining system for mice, comprising: non-corrosive magnet feet for the keyboard to secure the mouse on a metallic surface with or without coating or covering.
